(19) United States
(12) Patent Application Publication
(10) Pub. No.: US 2013/0020944 A1
(43) Pub. Date: Jan. 24, 2013

(54) LIGHT-EMITTING SYSTEM

(71) Applicants: Kun-Chieh CHANG, Taipei (TW); Shu-Ping Liu, Taipei (TW)

(72) Inventors: Kun-Chieh CHANG, Taipei (TW); Shu-Ping Liu, Taipei (TW)

(73) Assignee: King Diode Technology Co., Ltd.

(21) Appl. No.: 13/186,676

(22) Filed: Jul. 20, 2011

(51) Int. Cl. H05B 37/02

(52) U.S. Cl. 315/121

(57) ABSTRACT

A light-emitting system includes: a driver device operable to generate a driving signal that alternates between a first state, where voltage of the driving signal is higher than a predetermined threshold voltage, and a second state, where voltage of the driving signal is lower than the predetermined threshold voltage; and a light-emitting device connected electrically to the driver device for receiving the driving signal therefrom, and operable to enter a light-emitting state when the driving signal is in one of the first and second states, and to enter a non-light-emitting state when the driving signal is in the other of the first and second states. The light-emitting device includes at least one light-emitting diode.

### BACKGROUND OF THE INVENTION

1. Field of the Invention

The present invention relates to a light-emitting system, more particularly to a light-emitting system that alternates between light-emitting and non-light-emitting states.

2. Description of the Related Art

Generally, a conventional light-emitting system includes a constant-voltage driver device and at least one light-emitting component. The constant-voltage driver device is interconnected electrically between a power supply and the light-emitting component, and is operable to regulate voltage of a power signal flowing from the power supply, through the constant-voltage driver device, and to the light-emitting component, such that light emitted by the light-emitting component has a substantially uniform intensity.

However, the light-emitting component is subjected to ageing and variation in electrical characteristics caused by heat accumulation in the light-emitting component after a long duration of continuous use, which could reduce the light-emitting efficiency and could damage the light-emitting component.

### SUMMARY OF THE INVENTION

Therefore, an object of the present invention is to provide a light-emitting system capable of alleviating the aforesaid drawbacks of the prior art.

According to the present invention, a light-emitting system includes:

a driver device operable to generate a driving signal that alternates between a first state, where voltage of the driving signal is higher than a predetermined threshold voltage, and a second state, where voltage of the driving signal is lower than the predetermined threshold voltage; and

a light-emitting device connected electrically to the driver device for receiving the driving signal therefrom, and operable to enter a light-emitting state when the driving signal is in one of the first and second states, and to enter a non-light-emitting state when the driving signal is in the other of the first and second states, the light-emitting device including at least one light-emitting diode.

### BRIEF DESCRIPTION OF THE DRAWINGS

Other features and advantages of the present invention will become apparent in the following detailed description of the preferred embodiments with reference to the accompanying drawings, of which:

FIG. 1 is a circuit diagram to illustrate the first preferred embodiment of a light-emitting system according to the present invention;

FIG. 2 is a circuit diagram to illustrate the second preferred embodiment of a light-emitting system according to the present invention;

FIG. 3 is a circuit diagram to illustrate the third preferred embodiment of a light-emitting system according to the present invention;

FIG. 4 is a circuit diagram to illustrate the fourth preferred embodiment of a light-emitting system according to the present invention;

FIG. 5 is a circuit diagram to illustrate the fifth preferred embodiment of a light-emitting system according to the present invention;

FIG. 6 is a circuit diagram to illustrate the sixth preferred embodiment of a light-emitting system according to the present invention;

FIG. 7 is a circuit diagram to illustrate the seventh preferred embodiment of a light-emitting system according to the present invention; and

FIG. 8 is a circuit diagram to illustrate the eighth preferred embodiment of a light-emitting system according to the present invention.

### DETAILED DESCRIPTION OF THE PREFERRED EMBODIMENTS

Before the present invention is described in greater detail, it should be noted that like elements are denoted by the same reference numerals throughout the disclosure.

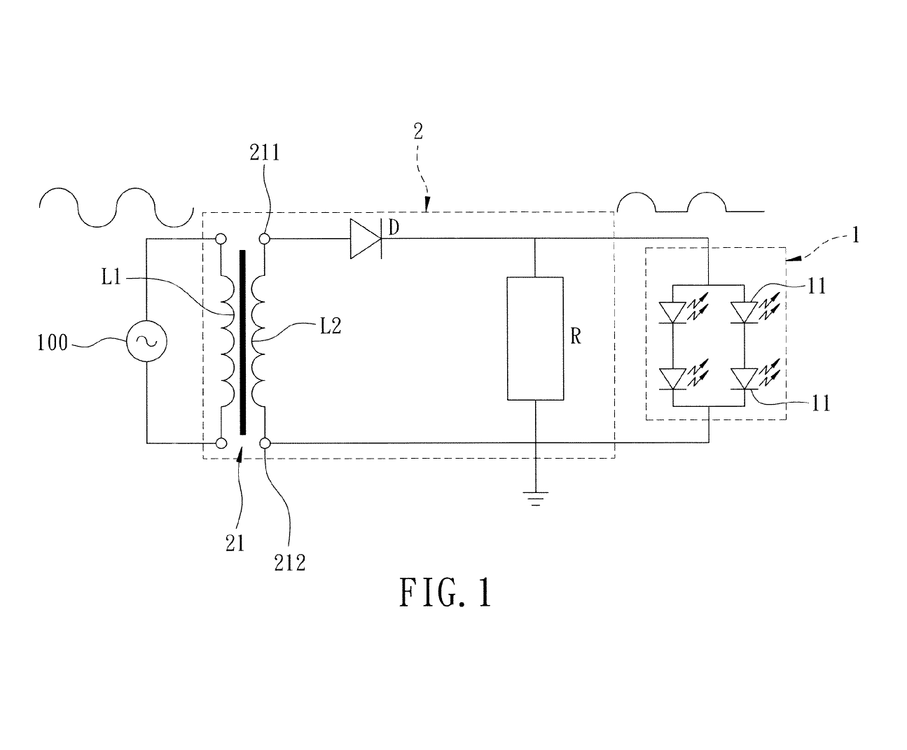

Referring to FIG. 1, the first preferred embodiment of a light-emitting system according to the present invention includes a light-emitting device 1 and a driver device 2.

The driver device 2 is disposed to receive an alternating-current (AC) input signal from such as a commercial power supply 100 (110V/60 Hz), is operable to perform voltage conversion upon the AC input signal so as to generate a driving signal that alternates between a first state, where voltage of the driving signal is higher than a predetermined threshold voltage, and a second state, where voltage of the driving signal is lower than the predetermined threshold voltage, and is connected electrically to the light-emitting device so as to provide the driving signal thereto.

The light-emitting device 1 is powered by the driving signal, includes a plurality of light-emitting diodes (LEDs) 11, and is configured to enter a light-emitting state, where the LEDs 11 are turned on, when the driving signal is in one of the first and second states, and to enter a non-light-emitting state, where the LEDS 11 are turned off, when the driving signal is in the other of the first and second states.

In this embodiment, the driving signal is a periodic signal that alternates regularly between the first and second states, such that the light-emitting device 1 switches regularly between the light-emitting and non-light-emitting states. However, in other embodiments, the driving signal may be an aperiodic signal that alternates irregularly between the first and second states, such that the light-emitting device switches irregularly between the light-emitting and non-light-emitting states. Furthermore, in other embodiments, the driver device 2 may be configured to generate a driving signal having an adjusted phase for driving a light-emitting device 1 that corresponds to a different phase.

The driving signal may be such as a sinusoidal signal, a square-wave signal, a pulse-wave signal, a triangular-wave signal, a bipolar exponential-wave signal, or a bipolar logarithmic-wave signal. Furthermore, the driver device 2 may be configured to generate the driving signal such that the driving signal has a relatively high frequency (e.g., 62.5 Hz). Thus, flickering of light emitted by the light-emitting device 1 is substantially unperceivable by the human eye due to the phenomenon of visible persistence. In such a configuration, light emitted by the light-emitting device 1 is rather steady and will not cause discomfort to the human eye.

In this embodiment, the driver device 2 is a half-wave rectifier including a transformer unit 21, a diode “D”, and a resistor “R”. The transformer unit 21 has a primary winding “L1” and a secondary winding “L2”. The primary winding “L1” is disposed to receive the AC input signal from the commercial power supply 100. The secondary winding “L2” has a first end 211 connected electrically to the anode of the diode “D”, and a grounded second end 212. The resistor “R” is connected electrically between the cathode of the diode “D” and ground. The transformer unit 21 is operable to convert the AC input signal into an intermediate driving signal based upon a turn ratio of the primary and secondary windings “L1”, “L2”, and to subsequently output the intermediate driving signal via the first end 212 of the secondary winding “L2”.

The diode “D” has an anode connected electrically to the first end 211 of the secondary winding “L2” for receiving the intermediate driving signal therefrom, and a cathode, and serves as a rectifier for rectifying the intermediate driving signal received thereby so as to generate the driving signal. Specifically, in this arrangement, the diode “D” is in a conductive state when voltage of the intermediate driving signal is positive, and is in a non-conductive state when otherwise.

The light-emitting device 1 is interconnected electrically between the cathode of the diode “D” and ground for receiving the driving signal from the diode “D”, and switches between the light-emitting and non-light-emitting states according to the driving signal. The resistor “R” is electrically connected across the light-emitting device 1. In this embodiment, the driving signal thus generated is a half-wave signal.

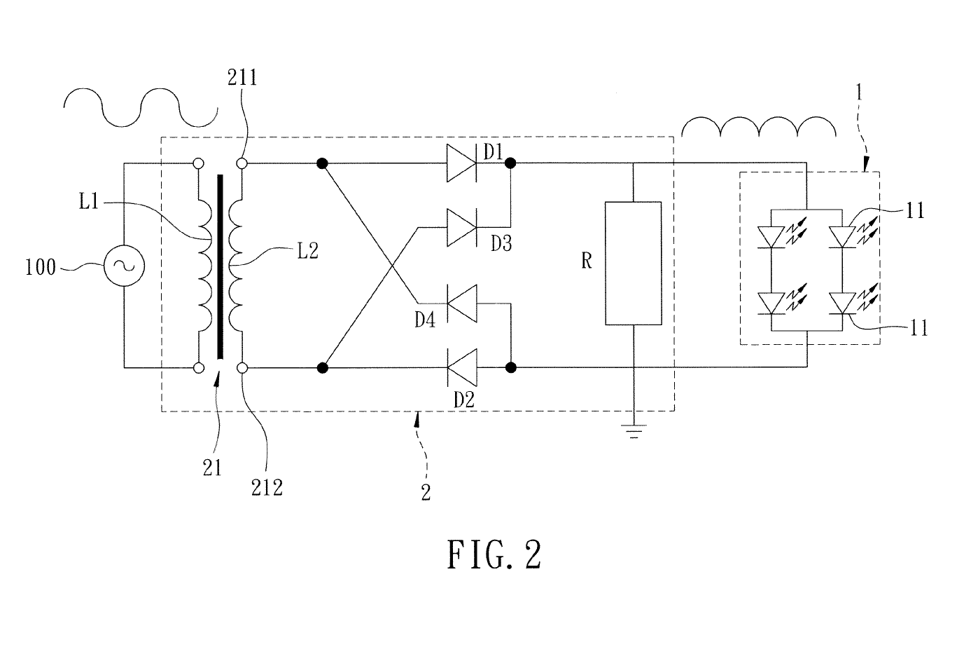

Referring to FIG. 2, in the second preferred embodiment, the driver device 2 is a full-wave rectifier including a transformer unit 21, a first diode “D1”, a second diode “D2”, a third diode “D3”, a fourth diode “D4”, and a resistor “R”.

The transformer unit 21 in the second preferred embodiment is identical to that in the first preferred embodiment, and will not be described in greater detail hereinafter for the sake of brevity.

The first diode “D1” has an anode connected electrically to the first end 211 of the secondary winding “L2”, and a cathode.

The second diode “D2” has a cathode connected electrically to the second end 212 of the secondary winding “L2”, and an anode connected electrically to ground.

The third diode D3 has a cathode connected electrically to the cathode of the first diode “D1”, and an anode connected electrically to the second end 212 of the secondary winding “L2”.

The fourth diode “D4” has a cathode connected electrically to the first end 211 of the secondary winding “L2”, and an anode connected electrically to the anode of the second diode “D2”. The diodes “D1”-“D4” cooperate to rectify the intermediate driving signal so as to generate the driving signal.

The light-emitting device 1 is interconnected electrically between the cathode of the first diode “D1” and the anode of the second diode “D2” for receiving the driving signal therefrom. The resistor “R” is connected electrically across the light-emitting device 1.

Specifically, in such a configuration: the first and second diodes “D1”, “D2” are in a conductive state and the third and fourth diodes “D3”, “D4” are in a non-conductive state when voltage of the intermediate driving signal is positive; and the first and second diodes “D1”, “D2” are in a non-conductive state and the third and fourth diodes “D3”, “D4” are in a conductive state when voltage of the intermediate driving signal is negative. The driving signal thus generated is a full-wave signal.

In this embodiment, the driver device 2 is a full-wave bridge rectifier. However, in other embodiments, the driver device 2 may be any other full-wave rectifier. Examples of other full-wave rectifiers include a center-tapped full-wave rectifier, a vacuum-tube full-wave rectifier, and a three-phase full-wave rectifier.

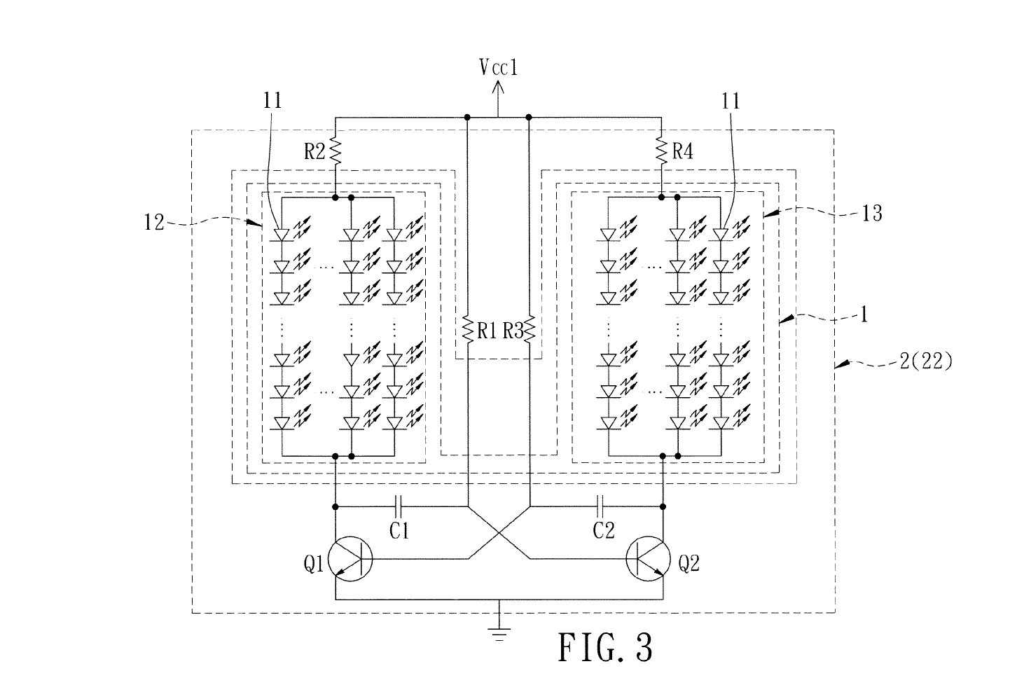

Referring to FIG. 3, in the third preferred embodiment, the driver device 2 is disposed to receive a direct-current (DC) bias voltage “Vcc1” at a bias voltage node, and is operable to perform voltage conversion upon the DC bias voltage so as to generate the driving signal. In this embodiment, the driver device 2 includes an astable multivibrator 22 including first and second transistors “Q1”, “Q2”, first and second capacitors “C1”, “C2”, and first, second, third, and fourth resistors “R1”-“R4”. Moreover, the light-emitting device 1 includes first and second light-emitting modules 12, 13.

The first transistor “Q1” is a bipolar junction transistor having a grounded emitter terminal, a base terminal, and a collector terminal that is connected electrically to the first light-emitting module 12.

The second transistor “Q2” is a bipolar junction transistor having a grounded emitter terminal, a base terminal, and a collector terminal that is connected electrically to the second light-emitting module 13.

The first capacitor “C1” is electrically interconnected between the collector terminal of the first transistor “Q1” and the base terminal of the second transistor “Q2”.

The second capacitor “C2” is electrically interconnected between the base terminal of the first first transistor “Q1” and the collector terminal of the second transistor “Q2”.

The first resistor “R1” is electrically interconnected between the base terminal of the second transistor “Q2” and the bias voltage node.

The second resistor “R2” and the first light-emitting module 12 are electrically interconnected between the collector terminal of the first transistor “Q1” and the bias voltage node.

The third resistor “R3” is electrically interconnected between the base terminal of the first transistor “Q1” and the bias voltage node.

The fourth resistor “R4” and the second light-emitting module 13 are electrically interconnected between the collector terminal of the second transistor “Q2” and the bias voltage node.

Through configuring the first and second transistors “Q1”, “Q2” to alternately enter a conductive state, the DC bias voltage is alternately provided to the first and second light-emitting modules 12, 13 such that the first and second light-emitting modules 12, 13 alternately enter a light-emitting state so as to emit light. In this embodiment, the driving signal is in the first state when the DC bias voltage is provided to one of the first and second light-emitting modules 12, 13, and is in the second state when the DC bias voltage is provided to the other of the first and second light-emitting modules 12, 13.

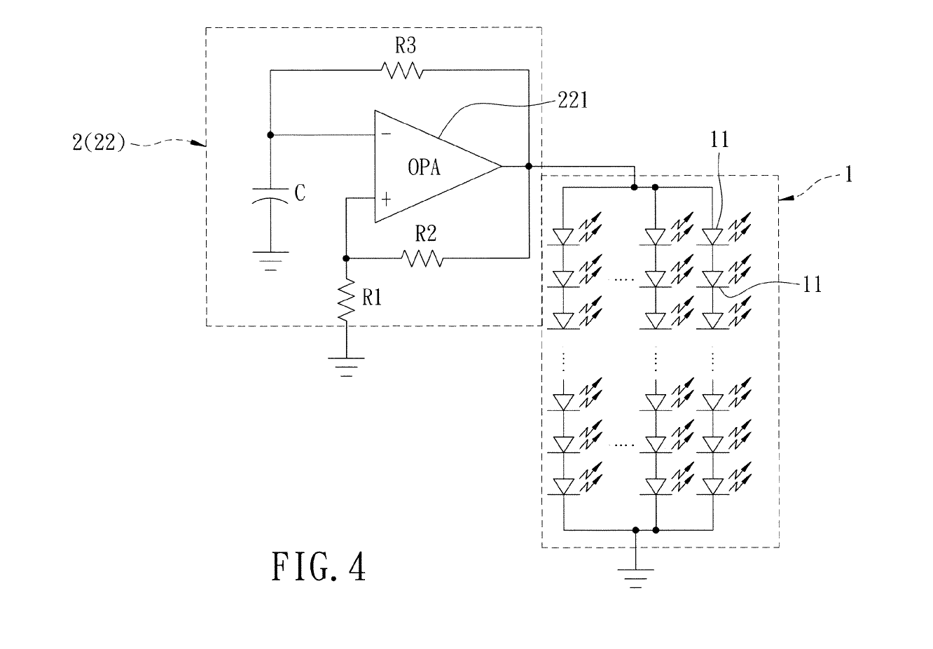

Referring to FIG. 4, in the fourth preferred embodiment, the driver device 2 includes an astable multivibrator 22 including an operational amplifier 221, a capacitor “C”, and first, second, and third resistors “R1”-“R3”. The operational amplifier 221 has inverting and non-inverting input terminals, and an output terminal that is connected electrically to the light-emitting device 1.

The capacitor “C” is electrically interconnected between ground and the inverting input terminal of the operational amplifier 221. The first resistor “R1” is electrically interconnected between ground and the non-inverting input terminal of the operational amplifier 221. The second resistor “R2” is electrically interconnected between the non-inverting input terminal and the output terminal of the operational amplifier 221. The third resistor “R3” is electrically interconnected between the output terminal and the inverting input terminal of the operational amplifier 221.

In such a configuration, the components of the driver device 2 cooperate to form a negative feedback Schmitt trigger for generating the driving signal, which is subsequently outputted to the light-emitting device 1 via the output terminal for driving the light-emitting device 1 to alternate between the light-emitting and non-light-emitting states.

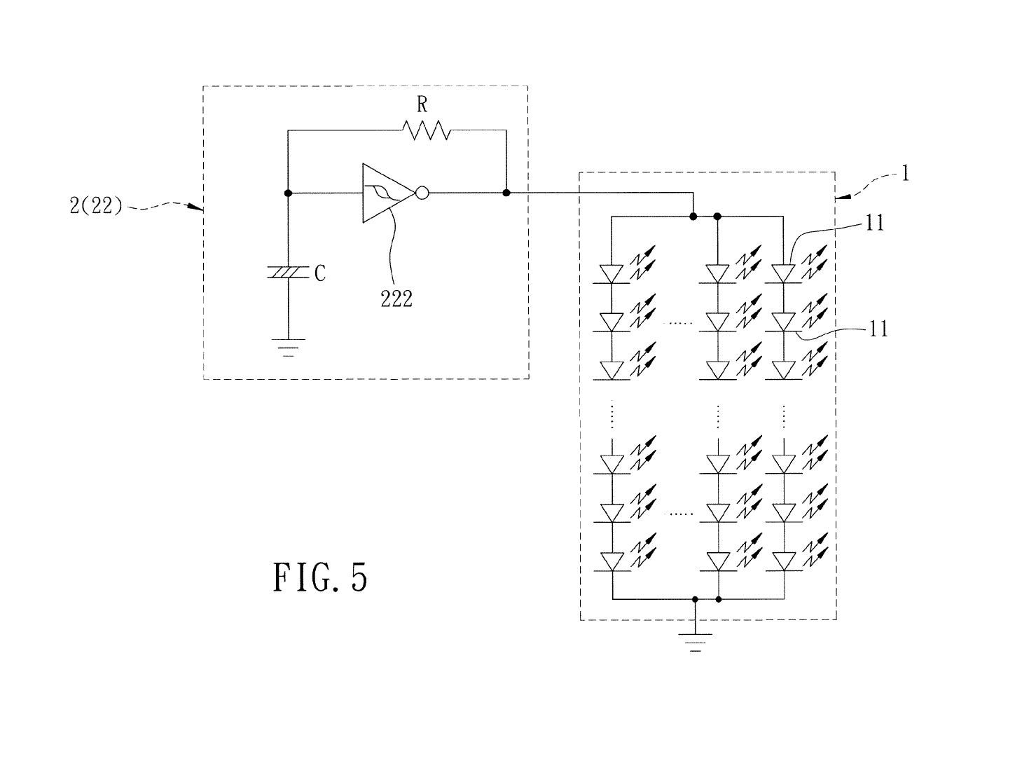

Referring to FIG. 5, in the fifth preferred embodiment, the driver device 2 includes an astable multivibrator 22 including a Schmitt trigger gate 222, a capacitor “C”, and a resistor “R”.

The Schmitt trigger gate 222 has an input terminal and an output terminal that is connected electrically to the light-emitting device 1. The capacitor “C” is electrically interconnected between ground and the input terminal of the Schmitt trigger gate 222. The resistor “R” is electrically interconnected between the input and output terminals of the Schmitt trigger gate 222.

During an initial stage of operation where the capacitor “C is not charged, the Schmitt trigger gate 222 is operable to output the driving signal at a voltage higher than the predetermined threshold voltage (i.e., the first state) for driving the light-emitting device 1 to enter the light-emitting state, the capacitor “C” being concurrently charged.

Next, when voltage across the capacitor “C” exceeds an upper threshold voltage of the Schmitt trigger gate 222, the Schmitt trigger gate 222 is operable to output the driving signal at a voltage lower than the predetermined threshold voltage (i.e., the second state) for driving the light-emitting device 1 to enter the non-light-emitting state, the capacitor “C” being concurrently discharged.

Subsequently, when voltage across the capacitor “C” drops below a lower threshold voltage of the Schmitt trigger gate 222, the Schmitt trigger gate 222 is operable for outputting the driving signal at the voltage higher than the predetermined threshold voltage (i.e., the first state) for driving the light-emitting device 1 to enter the light-emitting state, the capacitor “C” being concurrently charged.

Thus, the light-emitting device 1 alternates between the light-emitting and non-light-emitting states according to voltage of the driving signal received from the driver device 2. In this embodiment, the driving signal is a pulse-wave signal.

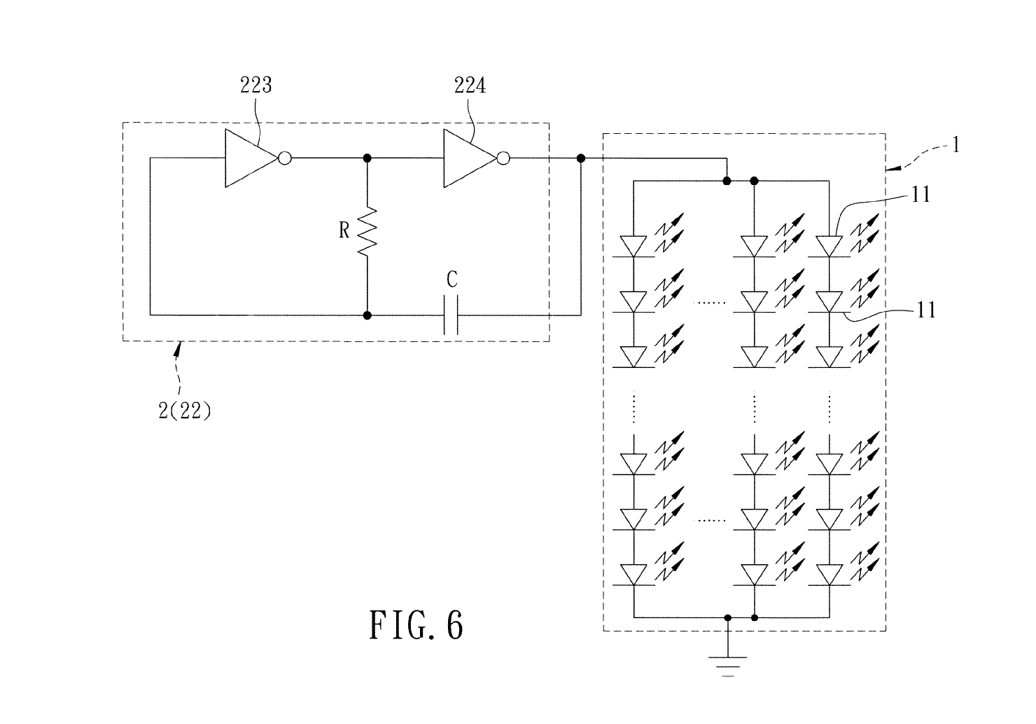

Referring to FIG. 6, in the sixth preferred embodiment, the driver device 2 includes an astable multivibrator 22 including first and second inverters 223, 224, a resistor “R”, and a capacitor “C”. Each of the first and second inverters 223, 224 has an input terminal and an output terminal, and includes a complementary metal-oxide-semiconductor (CMOS).

The output terminal of the first inverter 223 is connected electrically to the input terminal of the second inverter 224. The output terminal of the second inverter 224 is connected electrically to the light-emitting device 1. The resistor “R” is interconnected electrically between the input and output terminals of the first inverter 223. The capacitor “C” is interconnected electrically between the input terminal of the first inverter 223 and the output terminal of the second inverter 224.

During an initial stage of operation where the capacitor “C” is not charged, the first inverter 223 is operable to output an intermediate driving signal at a voltage higher than the predetermined threshold voltage (i.e., the first state), such that the second inverter 224 is operable to output the driving signal at a voltage lower than the predetermined threshold voltage (i.e., the second state), the capacitor “C” being concurrently charged by the intermediate driving signal.

Next, when voltage across the capacitor “C” exceeds a threshold voltage of the first and second inverters 223, 224, the first inverter 223 is operable to output the intermediate driving signal at the voltage lower than the predetermined threshold voltage (i.e., the second state) such that the second inverter 224 is operable to output the driving signal at the voltage higher than the predetermined threshold voltage (i.e., the first state), voltage across the capacitor “C” being instantaneously increased to the voltage higher than the predetermined threshold voltage (i.e., the first state) and the capacitor “C” beginning to discharge.

Subsequently, when voltage across the capacitor “C” drops below the threshold voltage of the first and second inverters 223, 224, the first inverter 223 is operable to output the intermediate driving signal at the voltage higher than the predetermined threshold voltage (i.e., the first state) such that the second inverter 224 is operable to output the driving signal at the voltage lower than the predetermined threshold voltage (i.e., the second state), voltage across the capacitor “C” being instantaneously decreased to the voltage lower than the predetermined threshold voltage (i.e., the second state) and the capacitor “C” beginning to charge.

The driving signal thus generated may be a square-wave signal or a pulse-wave signal.

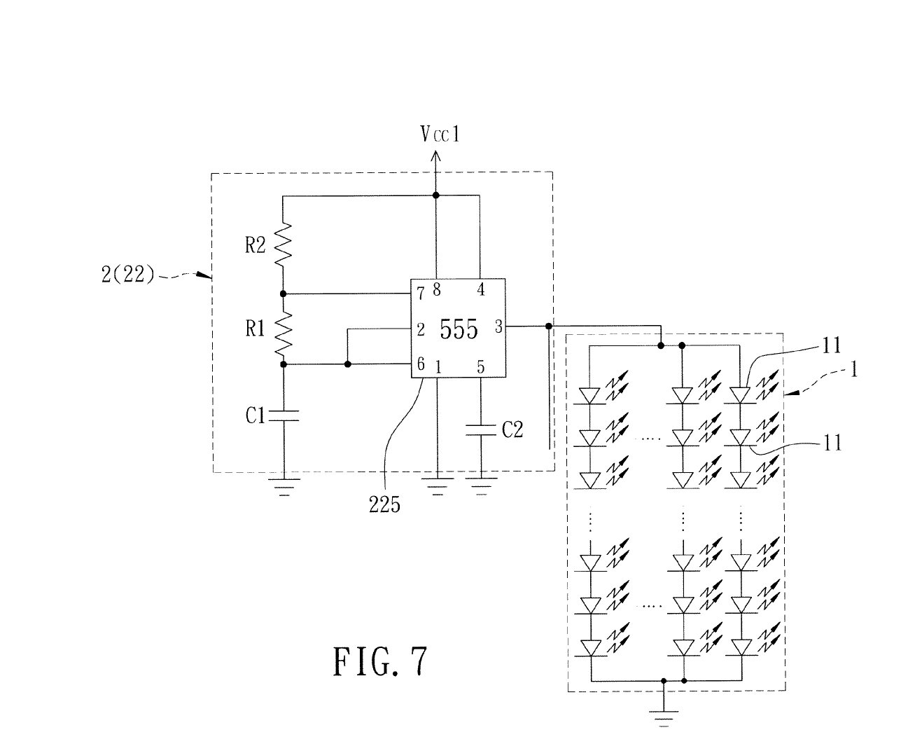

Referring to FIG. 7, in the seventh preferred embodiment, the driver device 2 is an astable multivibrator 22 including a 555-timer 225, first and second resistors “R1”, “R2”, and first and second capacitors “C1”, “C2”.

The 555-timer 225 is an integrated circuit having eight pins (or terminals), which are designated as: ground (pin 1), trigger (pin 2), output (pin 3), reset (pin 4), control (pin 5), threshold (pin 6), discharge (pin 7), and power supply (pin 8) that is disposed to receive a bias voltage “Vcc1” at a bias voltage node.

The first resistor “R1” is interconnected electrically between the threshold pin (pin 6) and the discharge pin (pin 7). The second resistor “R2” is interconnected electrically between the bias voltage node and the discharge pin (pin 7). The first capacitor “C1” is interconnected electrically between ground and the threshold pin (pin 6). The trigger pin (pin 2) is connected electrically to the threshold pin (pin 6). The second capacitor “C2” is interconnected electrically between the control pin (pin 5) and ground. The reset pin (pin 4) is connected electrically to the bias voltage node.

During an initial stage of operation, the 555-timer 225 is operable to output the driving signal at a voltage higher than the predetermined threshold voltage (i.e., the first state) via the output pin (pin 3), the first capacitor “C1” being concurrently charged by the bias voltage “Vcc1” through the first and second resistors “R1”, “R2”.

Next, when voltage across the first capacitor “C1” exceeds two thirds of the bias voltage “Vcc1”, the 555-timer 225 is operable to output the driving signal at a voltage lower than the predetermined threshold voltage (i.e., the second state), the first capacitor “C1” being concurrently discharged through the first resistor “R1”.

Subsequently, when voltage across the capacitor “C” drops below one third of the bias voltage “Vcc1”, the 555-timer 225 is operable to output the driving signal at the voltage higher than the predetermined threshold voltage (i.e., the first state), the first capacitor “C1” being concurrently charged by the bias voltage “Vcc1” through the first and second resistors “R1”, “R2”.

Thus, the light-emitting device 1 is operable to alternate between the light-emitting and non-light-emitting states based upon voltage of the driving signal.

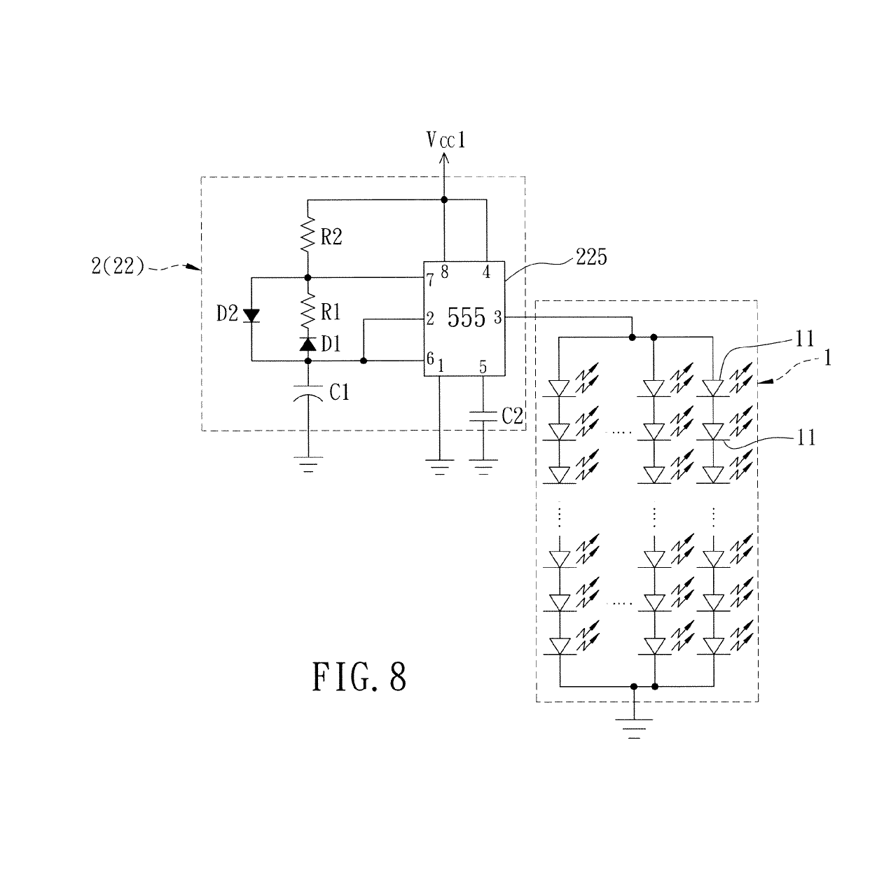

Referring to FIG. 8, in the eighth preferred embodiment, the driver device 2 is an astable multivibrator 22 including a 555-timer 225, first and second resistors “R1”, “R2”, first and second capacitors “C1”, “C2”, and first and second diodes “D1”, “D2”.

The 555-timer 225 in this embodiment is identical to that in the seventh preferred embodiment, and hence will not be described in greater detail hereinafter for the sake of brevity.

The first capacitor “C1” is interconnected electrically between ground and the threshold pin (pin 6). The trigger pin (pin 2) is connected electrically to the threshold pin (pin 6). The first resistor “R1” is connected electrically to the discharge pin (pin 7). The second resistor “R2” is interconnected electrically between the bias voltage node and the discharge pin (pin 7). The second capacitor “C2” is interconnected electrically between the control pin (pin 5) and ground. The first diode “D1” has an anode connected electrically to the first capacitor “C1”, and a cathode connected electrically to the first resistor “R1”. The second diode “D2” has an anode connected electrically to the discharge pin (pin 7), and a cathode connected electrically to the threshold pin (pin 6). The reset pin (pin 4) is connected electrically to the bias voltage node.

During an initial stage of operation, the 555-timer 225 is operable to output the driving signal at a voltage higher than the predetermined threshold voltage (i.e., the first state) via the output pin (pin 3), the first capacitor “C1” being concurrently charged by the bias voltage “Vcc1” via the second resistor “R2” and the second diode “D2”.

Next, when voltage across the first capacitor “C1” exceeds two thirds of the bias voltage “Vcc1”, the 555-timer 225 is operable to output the driving signal at a voltage lower than the predetermined threshold voltage (i.e., the second state), the first capacitor “C1” being concurrently discharged through the first resistor “R1” and the first diode “D1”.

Subsequently, when voltage across the first capacitor “C1” drops below one third of the bias voltage “Vcc1”, the 555-timer 225 is operable to output the driving signal at the voltage higher than the predetermined threshold voltage (i.e., the first state), the first capacitor “C1” being concurrently charged by the bias voltage “Vcc1” via the second resistor “R2” and the second diode “D2”.

In such a configuration, the driving signal thus generated is one of a square-wave signal and a pulse-wave signal. It is to be noted that, since the first capacitor “C1” is charged through the second resistor “R2” and discharged through the first resistor “R1”, charging duration of the first capacitor “C1” may be adjusted to be substantially identical to discharging duration of the same by configuring the first and second resistors “R1”, “R2” such that the first and second resistors “R1”, “R2” are identical to each other in resistance.

In summary, the driver device 2 of each of the preferred embodiments is operable to output a driving signal that alternates between the first and second states, thereby driving the light-emitting device 1 to alternate between the light-emitting and non-light-emitting states. In comparison with a light-emitting device driven by a conventional driver device that generates a constant driving signal, the light-emitting device 1 driven by the driver device 2 of the present invention generates less heat, such that the light-emitting device 1 is less susceptible to ageing caused by heat accumulation and consumes less energy.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A light-emitting system comprising:
a driver device operable to generate a driving signal that alternates between a first state, where voltage of the driving signal is higher than a predetermined threshold voltage, and a second state, where voltage of the driving signal is lower than the predetermined threshold voltage; and
a light-emitting device connected electrically to said driver device for receiving the driving signal therefrom, and operable to enter a light-emitting state when the driving signal is in one of the first and second states, and to enter a non-light-emitting state when the driving signal is in the other of the first and second states, said light-emitting device including at least one light-emitting diode.

2. The light-emitting system as claimed in claim 1, wherein said driver device is operable to rectify an alternating-current (AC) input signal received thereby so as to generate the driving signal.

3. The light-emitting system as claimed in claim 2, wherein said driver device includes a half-wave rectifier.

4. The light-emitting system as claimed in claim 2, wherein said driver device includes:
a transformer unit including first and second windings, said first winding being disposed to receive the AC input signal, said transformer unit being operable to perform voltage conversion upon the AC input signal based upon a turn ratio of said first and second windings so as to generate an intermediate driving signal, and to output the intermediate driving signal thus generated via said second winding;
a diode connected electrically to said second winding for receiving the intermediate driving signal therefrom, and operable to rectify the intermediate driving signal so as to generate the driving signal;
a resistor connected electrically across said light-emitting device.

5. The light-emitting system as claimed in claim 2, wherein said driver device includes a full-wave rectifier.

6. The light-emitting system as claimed in claim 5, wherein said driver device is one of a center-tapped full-wave rectifier, a vacuum-tube full-wave rectifier, and a three-phase full-wave rectifier.

7. The light-emitting system as claimed in claim 5, wherein said driver device includes:
a transformer unit including first and second windings, said first winding being disposed to receive the AC input signal, said transformer unit being operable to perform voltage conversion upon the AC input signal based upon a turn ratio of said first and second windings so as to generate an intermediate driving signal, and to output the intermediate driving signal thus generated via said second winding, which has first and second ends;
a first diode having an anode connected electrically to said first end of said second winding for receiving the intermediate driving signal therefrom, and a cathode connected electrically to said light-emitting device;
a second diode having a cathode connected electrically to said second end of said second winding, and an anode connected electrically to said light-emitting device;
a third diode having a cathode connected electrically to said cathode of said first diode, and an anode connected electrically to said second end of said second winding;
a fourth diode having an anode connected electrically to said anode of said second diode, and a cathode connected electrically to said first end of said second winding; and
a resistor connected electrically across said light-emitting device;
wherein said first, second, third, and fourth diodes cooperate to rectify the intermediate driving signal so as to generate the driving signal.

8. The light-emitting system as claimed in claim 1, wherein said driver device includes an astable multivibrator.

9. The light-emitting system as claimed in claim 8, wherein said light-emitting device includes first and second light-emitting modules, and said astable multivibrator is disposed to connect electrically to a bias voltage node, and includes:
a first transistor having a first terminal connected electrically to said first light-emitting module, a grounded second terminal, and a control terminal;
a second transistor having a first terminal connected electrically to said second light-emitting module, a grounded second terminal, and a control terminal;
a first capacitor interconnected electrically between said control terminal of said second transistor and said first terminal of said first transistor;
a second capacitor interconnected electrically between said control terminal of said first transistor and said first terminal of said second transistor;
a first resistor disposed to connect electrically said control terminal of said second transistor to the bias voltage node;
a second resistor disposed to connect electrically said first light-emitting module to the bias voltage node;
a third resistor disposed to connect electrically said control terminal of said first transistor to the bias voltage node; and
a fourth resistor disposed to connect electrically said second light-emitting module to the bias voltage node.

10. The light-emitting system as claimed in claim 9, wherein each of said first and second transistors is a bipolar junction transistor.

11. The light-emitting system as claimed in claim 8, wherein said astable multivibrator of said driver device includes:
an operational amplifier operable to generate the driving signal, and having inverting and non-inverting input terminals, and an output terminal that is connected electrically to said light-emitting device for providing the driving signal thereto;
a first resistor disposed to connect electrically said non-inverting input terminal to ground;
a second resistor interconnected electrically between said non-inverting input terminal and said output terminal;
a third resistor interconnected electrically between said inverting input terminal and said output terminal; and
a capacitor disposed to connect electrically said inverting input terminal to ground.

12. The light-emitting system as claimed in claim 8, wherein said astable multivibrator of said driver device includes:
a Schmitt trigger gate operable to generate the driving signal, and having an input terminal, and an output terminal that is connected electrically to said light-emitting device for providing the driving signal thereto;
a resistor interconnected electrically between said input and output terminals of said Schmitt trigger gate; and
a capacitor disposed to connect said input terminal of said Schmitt trigger gate to ground.

13. The light-emitting system as claimed in claim 8, wherein said astable multivibrator of said driver device includes:
first and second inverters each having input and output terminals, said second inverter being operable to generate the driving signal, said input terminal of said second inverter being connected electrically to said output terminal of said first inverter, said output terminal of said second inverter being connected electrically to said light-emitting device to provide the driving signal thereto;
a resistor interconnected electrically between said input and output terminals of said first inverter; and
a capacitor interconnected electrically between said input terminal of said first inverter and said output terminal of said second inverter.

14. The light-emitting system as claimed in claim 8, wherein said astable multivibrator of said driver device includes:
a 555-timer operable to generate the driving signal, and having a trigger pin, an output pin that is connected electrically to said light-emitting device for providing the driving signal thereto, a reset pin, a control pin, a threshold pin, and a discharge pin, said trigger pin being connected electrically to said threshold pin;
a first capacitor disposed to connect electrically said threshold pin to ground;
a second capacitor disposed to connect electrically said control pin to ground;
a first resistor interconnected electrically between said threshold pin and said discharge pin; and
a second resistor disposed to connect electrically said discharge pin to a bias voltage node.

15. The light-emitting system as claimed in claim 8, wherein said a stable multivibrator of said driver device includes:
a 555-timer operable to generate the driving signal, and having a trigger pin, an output pin that is connected electrically to said light-emitting device for providing the driving signal thereto, a reset pin, a control pin, a threshold pin, and a discharge pin, said trigger pin being connected electrically to said threshold pin;
a first capacitor disposed to connect electrically said threshold pin to ground;
a second capacitor disposed to connect electrically said control pin to ground;
a first resistor;
a second resistor disposed to connect electrically said discharge pin to a bias voltage node;
a first diode having an anode connected electrically to said threshold pin, and a cathode, said first resistor connecting electrically said cathode of said first diode to said discharge pin; and
a second diode having an anode connected electrically to said discharge pin, and a cathode connected electrically to said threshold pin.
